(19) United States
(12) Patent Application Publication
(10) Pub. No.: US 2021/0090598 A1
(43) Pub. Date: Mar. 25, 2021

(54) MAGNETIC DISK DEVICE AND METHOD

(71) Applicants: Kabushiki Kaisha Toshiba, Tokyo (JP); Toshiba Electronic Devices & Storage Corporation, Tokyo (JP)

(72) Inventor: Susumu Yoshida, Yokohama Kanagawa (JP)

(21) Appl. No.: 16/804,260

(22) Filed: Feb. 28, 2020

(30) Foreign Application Priority Data
Sep. 19, 2019 (JP) 2019-170526

(51) Int. Cl. G11B 5/596

(52) U.S. Cl. CPC G11B 5/59627; G11B 5/59688

(57) ABSTRACT

According to an embodiment, a magnetic disk device includes a magnetic disk, a magnetic head, and a controller. The magnetic disk records servo marks thereon. The controller determines, based on a time interval at which the servo marks are read by the magnetic head, whether the magnetic disk device has transitioned from a first state where a position of the magnetic disk device does not vary with time to a second state where a position of the magnetic disk device varies with time.

### CROSS-REFERENCE TO RELATED APPLICATIONS

This application is based upon and claims the benefit of priority from Japanese Patent Application No. 2019-170526, filed on Sep. 19, 2019; the entire contents of which are incorporated herein by reference.

### FIELD

Embodiments described herein relate generally to a magnetic disk device and a method.

### BACKGROUND

Conventional magnetic disk devices perform a predetermined process against vibration, shock, or the like.

### BRIEF DESCRIPTION OF THE DRAWINGS

FIG. 1 is a diagram illustrating an example of a configuration of a magnetic disk device according to an embodiment;

FIG. 2 is a diagram illustrating an example of a configuration of a magnetic disk according to an embodiment;

FIG. 3 is a graph illustrating a specific example of a method of detecting vibration, according to a first embodiment;

FIG. 4 is a flowchart illustrating an example of the operation of write frequency control performed by a magnetic disk device according to the first embodiment;

FIG. 5 is a flowchart illustrating an example of vibration detecting operation performed by the magnetic disk device according to the first embodiment;

FIG. 6 is a flowchart illustrating an example of operation of starting loop shaping control by the magnetic disk device according to the first embodiment;

FIG. 7 is a graph illustrating an example of transition of DIFF measured when shock is applied to a magnetic disk device according to a second embodiment;

FIG. 8 is a flowchart illustrating an example of operation of shock detection performed by the magnetic disk device according to the second embodiment; and

FIG. 9 is a flowchart illustrating an example of operation using a result of determination of whether shock is applied to the magnetic disk device, the operation being performed by the magnetic disk device according to the second embodiment.

### DETAILED DESCRIPTION

According to the present embodiment, a magnetic disk device includes a magnetic disk, a magnetic head, and a controller. Servo marks are recorded on the magnetic disk. The controller determines, based on a time interval at which the servo marks are read by the magnetic head, whether the magnetic disk device has transitioned from a first state where a position of the magnetic disk device does not vary with time to a second state where a position of the magnetic disk device varies with time.

A magnetic disk device and a method, according to embodiments, will be described below in detail with reference to the accompanying drawings. It should be noted that the present invention is not limited to these embodiments.

### First Embodiment

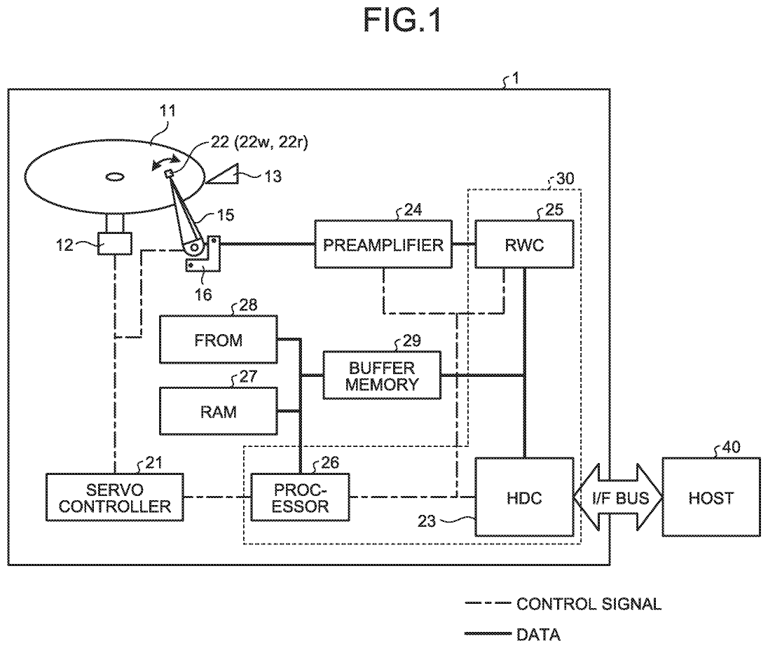

FIG. 1 is a diagram illustrating an example of a configuration of a magnetic disk device 1 according to an embodiment.

The magnetic disk device 1 is connected to a host 40. The magnetic disk device 1 is operable to receive an access command, such as a write command or a read command, from the host 40.

The magnetic disk device 1 includes a magnetic disk 11 that has a magnetic layer formed on the surface thereof. The magnetic disk device 1 writes data on the magnetic disk 11 or reads data from the magnetic disk 11 in response to the access command.

Writing and reading data are performed via a magnetic head 22. Specifically, the magnetic disk device 1 includes a spindle motor 12, a servo controller 21, the magnetic head 22, an actuator arm 15, a voice coil motor (VCM) 16, a ramp 13, a preamplifier 24, a read/write channel (RWC) 25, a hard disk controller (HDC) 23, a buffer memory 29, and a processor 26, in addition to the magnetic disk 11.

The magnetic disk 11 is rotated about a rotation axis at a predetermined rotation speed by the spindle motor 12. The spindle motor 12 is rotationally driven by the servo controller 21.

The magnetic head 22 writes and reads data on and from the magnetic disk 11 by using a write element 22w and a read element 22r provided to the magnetic head 22. Furthermore, the magnetic head 22 is attached to an end of the actuator arm 15. The magnetic head 22 is moved in a radial direction of the magnetic disk 11 by the VCM 16 driven by the servo controller 21. For example, during non-rotation of the magnetic disk 11, the magnetic head 22 is retracted to the ramp 13.

When reading a signal from the magnetic disk 11 by the magnetic head 22, the preamplifier 24 amplifies the signal and outputs the amplified signal to be supplied to the RWC 25. The preamplifier 24 amplifies a signal corresponding to write data supplied from the RWC 25 and supplies the amplified signal to the magnetic head 22.

The HDC 23, for example, controls transmission/reception of data to/from the host 40 via an I/F bus, controls the buffer memory 29, and corrects an error of read data.

The buffer memory 29 is used as a buffer for data transmitted to the host 40 and data received from the host 40. For example, the buffer memory 29 is used to temporarily store data to be written on the magnetic disk 11.

The buffer memory 29 is constituted by, for example, a volatile memory which operates at high speed. The type of a memory constituting the buffer memory 29 is not limited to a specific type. The buffer memory 29 may be constituted by a dynamic random access memory (DRAM) or a static random access memory (SRAM).

The RWC 25 modulates write data supplied from the HDC 23, and supplies the modulated signal to the preamplifier 24. Furthermore, the RWC 25 demodulates a signal read from the magnetic disk 11 and supplied from the preamplifier 24 and outputs the demodulated signal as digital data to the HDC 23.

The processor 26 includes, for example, a central processing unit (CPU). A RAM 27, a flash read only memory (FROM) 28, and the buffer memory 29 are connected to the processor 26.

The RAM 27 includes, for example, a DRAM or SRAM. The RAM 27 is used as an operation memory by the processor 26. The RAM 27 is used for an area into which firmware (program data) is loaded or an area in which various management data are stored.

An FROM 28 is an example of a nonvolatile memory. The processor 26 controls the whole of the magnetic disk device 1 according to firmware previously stored in the FROM 28 and on the magnetic disk 11. For example, the processor 26 loads firmware previously stored in the FROM 28 and on the magnetic disk 11 into the RAM 27 and controls the servo controller 21, the preamplifier 24, the RWC 25, the HDC 23, and the like according to the loaded firmware.

Note that a configuration including the RWC 25, the processor 26, and the HDC 23 may also be regarded as a controller 30. The controller 30 may include elements such as the RAM 27, the FROM 28, the buffer memory 29, and the RWC 25.

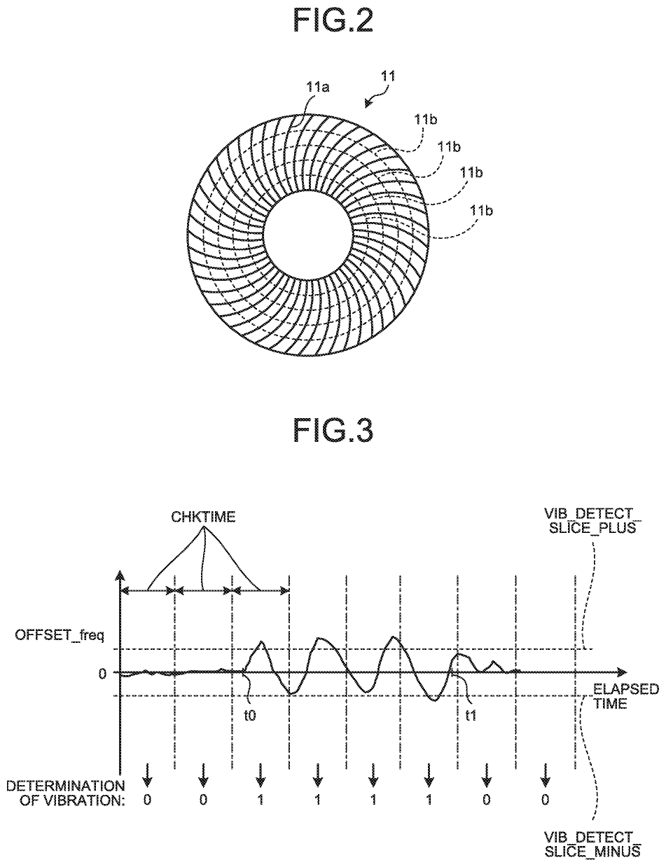

FIG. 2 is a diagram illustrating an example of a configuration of the magnetic disk 11 according to an embodiment. Servo information is recorded in the magnetic layer formed on a surface of the magnetic disk 11 by, for example, a servo writer before shipment. The servo information includes a servo mark, sector/cylinder information, and a burst pattern. Note that the servo information may be recorded on the magnetic disk 11 by self-servo write (SSW) after shipment. FIG. 2 illustrates servo zones 11a radially arranged on the magnetic disk 11 as an example of arrangement of servo zones in each of which the servo information is written.

In radial directions of the magnetic disk 11, a plurality of concentric tracks 11b are provided at a predetermined pitch. Each track 11b crosses the servo zones 11a at predetermined intervals. One or more sectors are circumferentially formed between servo zones 11a around each track 11b. For each sector, the magnetic head 22 writes data (i.e., data requested to be written by a write command from the host 40) and reads the written data.

On each track 11b, servo marks are designed to be provided at equal intervals. Therefore, ideally, time intervals at which servo marks are read should always be constant. This designed time interval is referred to as a specified time period.

However, in practice, variations in the quality of servo marks written on the magnetic disk 11 or variations in the rotation rate of the magnetic disk 11 may cause variations in time intervals at which servo marks are read. Therefore, assuming that a write frequency for writing data is set to be constant, if the time interval at which servo marks are read is shorter than the specified time period, there is a possibility that all of a specified amount of data cannot be written between the servo zones 11a.

Therefore, the controller 30 (e.g., the processor 26) performs control for adjusting the write frequency according to the time interval at which servo marks are read. For example, when the time interval at which servo marks are read is shorter, the controller 30 sets the write frequency higher. Furthermore, when the time interval at which servo marks are read is longer, the controller 30 sets the write frequency lower. Therefore, even when the time interval at which servo marks are read increases or decreases relative to the specified time period, variations in the amount of data to be written between servo marks can be suppressed.

Here, as an example, the controller 30 calculates an offset amount (represented as OFFSET_freq) by subtracting the specified time period from the time interval at which servo marks are read. In the description of this embodiment, the controller 30 achieves the adjustment of the write frequency using a write frequency having an offset from the reference frequency by an amount proportional to OFFSET_freq. However, the method of adjusting the write frequency according to the time interval at which servo marks are read is not limited to this description.

Here, the magnetic disk device 1 may be subjected to external vibration. For example, the magnetic disk device 1 may be subjected to vibration due to rotation of a fan included in a rack on which the magnetic disk device 1 is mounted. In another example, the magnetic disk device 1 may be subjected to vibration due to operation of another magnetic disk device mounted on a rack adjacently to the magnetic disk device 1. In still another example, the magnetic disk device 1 may be shaken due to an earthquake.

When the magnetic disk device 1 (particularly the magnetic disk 11) is vibrated in a rotation axis direction, the vibration causes a reduction of accuracy in radial positioning of the magnetic head 22. The controller 30 (e.g., the processor 26) is configured to perform loop shaping control to suppress the reduction of accuracy in the magnetic head positioning.

According to the loop shaping control, a component having a specific frequency is emphasized and extracted from a positional error. Then, a drive signal supplied to the voice coil motor 16 is corrected by using the component extracted. As the specific frequency, for example, a natural frequency according to the vibration of the magnetic disk 11 in the rotation axis direction is selected. This control allows the voice coil motor 16 to suppress a radial displacement of the magnetic head 22 which is caused by the vibration at the specific frequency.

Here, in the case where the loop shaping control is performed when the magnetic disk device 1 (particularly the magnetic disk 11) is not vibrated, the positioning of the magnetic head 22 may be adversely affected. In order to switch on or off the loop shaping control, a mechanism for easily and quickly detecting whether the magnetic disk 11 is vibrated, in other words, whether vibration is applied to the magnetic disk device 1.

In a first embodiment, the controller 30 determines whether or not vibration is applied to the magnetic disk device 1 on the basis of the time intervals at which servo marks are read. When vibration is applied to the magnetic disk device 1, the vibration propagates to the magnetic disk 11 via a housing of the magnetic disk device 1. When the magnetic disk 11 is subjected to vibration, the magnetic disk 11 vibrates at a natural frequency in the rotation axis direction. The vibration of the magnetic disk 11 at the natural frequency in the rotation axis direction changes the time interval at which servo marks are read. An amount of a change of the time interval at which servo marks are read increases or decreases according to the magnitude of the vibration of the magnetic disk 11. The controller 30 determines the presence or absence of application of vibration on the basis of the amount of a change of the time interval at which servo marks are read.

FIG. 3 is a graph illustrating a specific example of a method of detecting vibration, according to the first embodiment. In this figure, the vertical axis indicates an offset from the specified time period (i.e., OFFSET_freq) with respect to the time interval at which servo marks are read. Note that since the specified time period is constant, the vertical axis substantially corresponds to the time interval at which servo marks are read. The horizontal axis indicates elapsed time.

In FIG. 3, time intervals “CHKTIME” each represent a cycle for determining whether vibration is applied. Slots of the time intervals CHKTIME are each represented as a determination time segment. “VIB_DETECT_SLICE_PLUS” is a positive threshold value for the determination, and “VIB_DETECT_SLICE_MINUS” is a negative threshold value for the determination.

A result of the determination of whether vibration is being applied is used to turn on or off the loop shaping control. Therefore, an upper limit value of a range for which it is preferable not to perform the loop shaping control in the range of possible OFFSET_freq can be set as VIB_DETECT_SLICE_PLUS. In addition, a lower limit value of the range for which it is preferable not to perform the loop shaping control in the range of possible OFFSET_freq can be set as VIB_DETECT_SLICE_MINUS. VIB_DETECT_SLICE_PLUS and the absolute value of VIB_DETECT_SLICE_MINUS are, for example, equal to each other. VIB_DETECT_SLICE_PLUS and the absolute value of VIB_DETECT_SLICE_MINUS need not be equal.

In the example shown in FIG. 3, application of vibration of a predetermined magnitude to the magnetic disk device 1 is started at time t0, and the application of vibration is stopped at time t1. In this figure, when the application of vibration is started, the value of OFFSET_freq starts to oscillate in response to the start of the application of vibration.

Then, in a determination time segment where OFFSET_freq exceeds VIB_DETECT_SLICE_PLUS even once or OFFSET_freq falls below VIB_DETECT_SLICE_MINUS even once, it is determined that vibration is applied. In a determination time segment where OFFSET_freq has never exceeded VIB_DETECT_SLICE_PLUS and OFFSET_freq has never fallen below VIB_DETECT_SLICE_MINUS, it is determined that vibration is not applied.

Thereby, it is detected that vibration is applied in each determination time segment from time t0 to time t1.

Note that the result “1” of the detection of vibration means that it is determined that the vibration is applied. On the other hand, “0” means that it is determined that vibration is not applied. For example, when a vibration detection result indicates “1”, the loop shaping control is performed. When a vibration detection result indicates “0”, loop shaping control is not performed.

As described above, in the first embodiment, since vibration is detected on the basis of OFFSET_freq monitored for write frequency control, that is, on the basis of the time intervals at which servo marks are read, detection of vibration does not require a sensor dedicated to detecting vibration. In other words, it is possible to detect vibration with a simple configuration.

As a method (represented as a comparative example) compared to the first embodiment, the method described below may be considered. For example, when it is desired to detect vibration, the loop shaping control is started. Then, a specific frequency component included in a positional error, which is obtained in the process of loop shaping control, is acquired. The magnitude of the specific frequency component included in the positional error is considered to correspond to the magnitude of vibration. Therefore, determination of whether vibration is applied may be performed on the basis of the magnitude of the specific frequency component of the positional error.

However, the loop shaping control usually requires changing various parameters including a parameter for correcting or adjusting a position of a magnetic head to follow a track. Then, after changing the parameters, it is necessary to wait for stabilization of the control. In other words, according to the comparative example, a longer time is required to determine whether vibration is applied.

Furthermore, during a period from the start of the loop shaping control to the stabilization of the control, not only determining whether vibration is applied but also writing and reading data are not permitted. Therefore, performance of reading data from or writing data to the magnetic disk device 1 deteriorates.

According to the first embodiment, vibration is detected on the basis of the time intervals at which servo marks are read, and the time intervals at which servo marks are read are always monitored during access to the magnetic disk 11. In other words, vibration can be detected without interrupting reading data from or writing data to the magnetic disk device 1.

Furthermore, according to the first embodiment, it is unnecessary to switch control for detecting vibration. Therefore, unlike the comparative example, vibration can be detected in real time. Furthermore, according to the first embodiment, unlike the comparative example, the control does not need to be switched, and the amount of firmware code can be reduced.

Next, operation of the magnetic disk device 1 according to the first embodiment will be described.

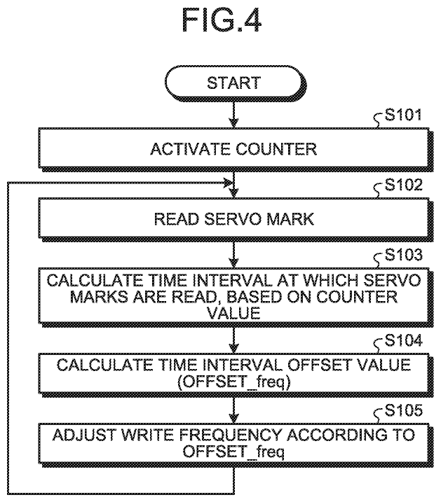

FIG. 4 is a flowchart illustrating an example of write frequency control operation performed by a magnetic disk device 1 according to the first embodiment. This operation can be performed for both of writing data to and reading data from the magnetic disk 11.

Firstly, the controller 30 activates (starts) a counter (S101). The counter outputs time information serving as a reference for calculating a time interval at which servo marks are read. The counter may be a software counter achieved by the processor 26 or may be a hardware counter provided inside or outside the controller 30.

Next, when a servo mark is read by the magnetic head 22 (S102), the controller 30 calculates a time interval at which servo marks are read, on the basis of a value of the counter (S103).

For example, the magnetic head 22 reads a servo mark and outputs a read signal corresponding to the servo mark. The read signal is amplified by the preamplifier 24 and demodulated by the RWC 25. When the RWC 25 determines that the demodulated read signal represents a servo mark, the processor 26 acquires a value of the counter.

A processing group of S102 to S105 including the processing of S103 constitutes loop processing. In other words, the processing of S103 is repeatedly executed. The controller 30 calculates a time interval at which servo marks are read by subtracting a value of the counter acquired last time, from a value of the counter acquired this time. Note that when the processing of S103 is performed for the first time, the controller 30 may regard a value of the counter as the time interval at which servo marks are read.

After the processing of S103, the controller 30 subtracts the specified time period from the time interval obtained by the calculation and calculates OFFSET_freq (S104).

Then, the controller 30 adjusts a write frequency according to OFFSET_freq (S105). In an example, the controller 30 increases the write frequency as OFFSET_freq increases. In addition, the controller 30 decreases the write frequency as OFFSET_freq decreases.

After the processing of S105, the processing of S102 is executed again.

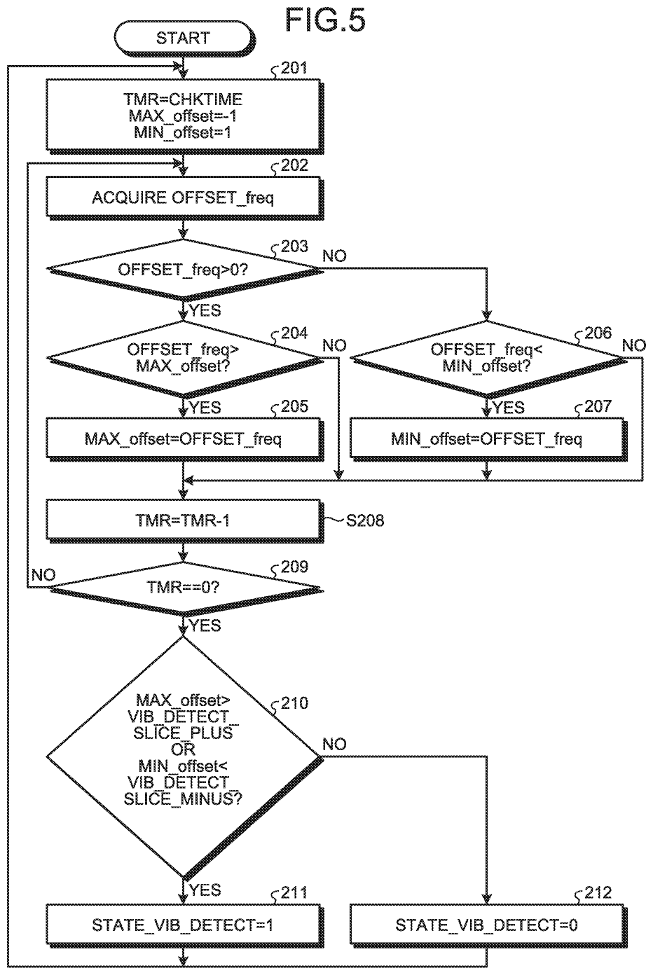

FIG. 5 is a flowchart illustrating an example of vibration detecting operation performed by the magnetic disk device 1 according to the first embodiment. Note that in this figure, “CHKTIME” represents the length of the determination time segment. Furthermore, “MAX_offset” is a parameter to which a maximum value of OFFSET_freq in one determination time segment is set. Still furthermore, “MIN_offset” is a parameter to which a minimum value of OFFSET_freq in one determination time segment is set. Still furthermore, STATE_VIB_DETECT is a parameter to which a result of determination of whether vibration is applied is set. “TMR” is a parameter for counting a lapse of time within one determination time segment.

As described above, “VIB_DETECT_SLICE_PLUS” and “VIB_DETECT_SLICE_MINUS” are threshold values to be compared with OFFSET_freq.

Firstly, the controller 30 sets an initial value to each of TMR, MAX_offset, and MIN_offset (S201). Here, the controller 30 sets CHKTIME to TMR, sets “−1” to MAX_offset, and sets “1” to MIN_offset. The initial values set to MAX_offset and MIN_offset are not limited to these values. Each of MAX_offset and MIN_offset may be set to 0.

After the processing of S201, the controller 30 acquires OFFSET_freq obtained in the processing of S104 (S202) and determines whether OFFSET_freq is greater than 0 (S203). This processing is performed to determine whether OFFSET_freq is a positive value or a negative value. Therefore, the controller 30 may determine whether OFFSET_freq is 0 or more, instead of determining whether OFFSET_freq is larger than 0.

When OFFSET_freq is larger than 0 (S203: Yes), the controller 30 determines whether OFFSET_freq is larger than MAX_offset (S204). In other words, the controller 30 determines whether the latest OFFSET_freq exceeds a maximum value observed in the past within the same determination time segment.

If OFFSET_freq is larger than MAX_offset (S204: Yes), the controller 30 overwrites MAX_offset with OFFSET_freq (S205). In other words, a maximum value stored as MAX_offset is updated to the latest OFFSET_freq. If OFFSET_freq is not larger than MAX_offset (S204: No), the processing of S205 is skipped.

If OFFSET_freq is not larger than 0 (S203: No), the controller 30 determines whether OFFSET_freq is smaller than MIN_offset (S206). In other words, the controller 30 determines whether the latest OFFSET_freq is below a minimum value observed in the past within the same determination time segment.

If OFFSET_freq is smaller than MIN_offset (S206: Yes), the controller 30 overwrites MIN_offset with OFFSET_freq (S207). In other words, a minimum value stored as MIN_offset is updated to the latest OFFSET_freq. If OFFSET_freq is not smaller than MIN_offset (S206: No), the processing of S207 is skipped.

When OFFSET_freq is not larger than MAX_offset (S204: No), or after the processing of S205, or when OFFSET_freq is not smaller than MIN_offset (S206: No), or after the processing of S207, the controller 30 decrements TMR by 1 (S208). Then, the controller 30 determines whether TMR is 0 (S209). If the TMR is not 0 (S209: No), the control proceeds to S202.

If the TMR is 0 (S209: Yes), the controller 30 determines whether at least one of the following formulas (1) and (2) is established (S210). In other words, the controller 30 compares each of the maximum value and the minimum value observed in one determination time segment with the corresponding threshold value.

MAX_offset>VIB_DETECT_SLICE_PLUS (1)

MIN_offset<VIB_DETECT_SLICE_MINUS (2)

If at least one of formulas (1) and (2) is satisfied (S210: Yes), in other words, the maximum value exceeds the threshold value (VIB_DETECT_SLICE_PLUS) or the minimum value is below the threshold value (VIB_DETECT_SLICE_MINUS), it is estimated that vibration is applied. Therefore, the controller 30 sets “1”, which is a value indicating that vibration is applied, to STATE_VIB_DETECT (S211).

If neither of the formulas (1) and (2) is satisfied (S210: No), the controller 30 sets “0”, which is a value indicating that vibration is not applied, to STATE_VIB_DETECT (S212).

After the processing of S211 or S212, the control proceeds to S201.

In this way, when the processing is started for one determination time segment, TMR is decremented by 1 each time the loop processing from S202 to S209 is executed after OFFSET_freq is acquired. In each loop processing, updating of MAX_offset or MIN_offset is executed or not executed according to OFFSET_freq. Then, when the processing for one determination time segment ends, TMR becomes 0, and the processing exits from the loop processing. In S210, on the basis of MAX_offset and MIN_offset, it is determined whether vibration has been applied within the determination time segment. After the determination, the control proceeds to S201 again, and the processing starts for a next determination time segment.

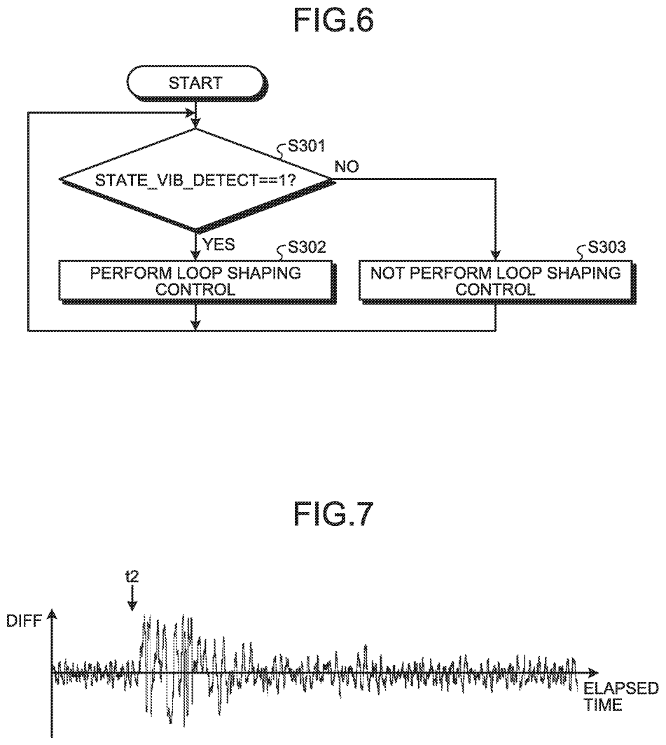

FIG. 6 is a flowchart illustrating an example of operation of starting loop shaping control by the magnetic disk device 1 according to the first embodiment.

The controller 30 monitors STATE_VIB_DETECT. Then, the controller 30 determines whether STATE_VIB_DETECT is 1 (S301). When STATE_VIB_DETECT is “1” (S301: Yes), in other words, when a determination that vibration is applied is made, the controller 30 performs loop shaping control (S302). When STATE_VIB_DETECT is not “1” (S301: No), in other words, when a determination that vibration is not applied is made, the controller 30 does not perform loop shaping control (S303). After the processing of S302 or S303, the control proceeds to S301.

The operation shown in FIG. 6 is merely an example. The controller 30 may be configured to perform the loop shaping control when STATE_VIB_DETECT is 1 in all of a predetermined number of consecutive determination time segments, and, not to perform loop shaping control when STATE_VIB_DETECT is 0 in all of a predetermined number of consecutive determination time segments. In other words, the controller 30 starts the loop shaping control according to any method using a result of the determination of whether vibration is applied.

Note that in the first embodiment described above, the results of the determination of whether vibration is applied are used to control execution and stop of the loop shaping control. The result of the determination of whether vibration is applied, the result being obtained by the method described in the first embodiment, can be used for any control in addition to the control of execution and stop of the loop shaping control.

As described above, according to the first embodiment, the controller 30 measures the time intervals at which servo marks are read by the magnetic head 22. Then the controller 30 determines whether vibration is applied to the magnetic disk device 1 on the basis of the measured time intervals.

Therefore, it is possible to detect vibration without requiring a sensor for detecting the vibration. In other words, it is possible to detect vibration with a simple configuration.

Furthermore, it is also possible to detect vibration without interrupting reading data from or writing data to the magnetic disk device 1. Still furthermore, since the control does not need to be switched to detect vibration, it is possible to detect vibration in real time. Still furthermore, since the control does not need to be switched to detect vibration, the amount of firmware code can be reduced.

Furthermore, according to the first embodiment, the controller 30 starts the loop shaping control for positioning the magnetic head 22 in response to determination that vibration is applied to the magnetic disk device 1.

This configuration eliminates the need to activate loop shaping control to detect vibration as described in the comparative example.

Furthermore, according to the first embodiment, the controller 30 calculates OFFSET_freq that is a difference between the time interval at which servo marks are read and the specified time period. Then, the controller 30 determines whether vibration is applied to the magnetic disk device 1 on the basis of comparison between OFFSET_freq and the threshold values (VIB_DETECT_SLICE_PLUS and VIB_DETECT_SLICE_MINUS).

Note that a method of determining whether vibration is applied is not limited to the above-described method. The controller 30 may be configured to obtain an amplitude of the time interval of read servo marks in a manner different from the above-described method and detect vibration on the basis of comparison between the amplitude and a predetermined threshold value.

Furthermore, the controller 30 may perform appropriate filtering, such as averaging, on the time intervals at which servo marks are read and detect vibration on the basis of a value obtained by the filtering. In other words, the controller 30 can perform any processing on the time intervals at which servo marks are read.

Furthermore, according to the first embodiment, the controller 30 changes the write frequency for writing data to the magnetic disk 11 by an amount corresponding to OFFSET_freq.

In other words, the controller 30 uses OFFSET_freq for both of the write frequency control and the detection of vibration. Since the write frequency control and the detection of vibration are performed on the basis of common data (OFFSET_freq), the configuration of the controller 30 and the configuration of the firmware can be simplified.

### Second Embodiment

When the magnetic disk device 1 is mounted, for example, to a portable computer, and if a user drops or raises the portable computer or hits the portable computer against another object, shock may be applied to the magnetic disk device 1. In the second embodiment, the controller 30 is configured to determine whether shock is applied to the magnetic disk device 1. Hereinafter, different points from the first embodiment will be described in detail, and the same processing as that of the first embodiment will be briefly described or omitted.

Vibration is a change in magnitude of an amount relating to a certain coordinate system, between a state in which the magnitude is larger than an average value or a reference value and a state in which the magnitude is smaller than the average value or the reference value, the states being repeated at least once. Therefore, as described in the first embodiment, detection of the vibration can be performed on the basis of an offset from a reference value (e.g., OFFSET_freq) or amplitude with respect to time intervals at which servo marks are read.

On the other hand, shock is to instantaneously apply a large external force. Therefore, the controller 30 calculates an amount of a change of OFFSET_freq in time (DIFF) and detects a shock on the basis of DIFF.

More specifically, the controller 30 acquires OFFSET_freq through a series of processing illustrated in FIG. 4. Then, the controller 30 calculates the amount of a change of OFFSET_freq in time (DIFF) and detects a shock on the basis of comparison between DIFF and a predetermined threshold value (represented as SHK_DETECT_DIFFSLICE). Here, it is assumed that SHK_DETECT_DIFFSLICE has a positive value, and the absolute value of the amount of a change of OFFSET_freq in time (DIFF) is compared with SHK_DETECT_DIFFSLICE.

FIG. 7 is a graph illustrating an example of transition of DIFF measured when shock is applied to a magnetic disk device 1 according to the second embodiment. As illustrated in this figure, it is found that the shock is applied at timing t2, and then the magnetic disk device 1 is vibrated. The amplitude of vibration attenuates with time.

Note that the controller 30 also compares OFFSET_freq with another threshold value (SHK_DETECT_OFFSETSLICE) to detect the shock. SHK_DETECT_OFFSETSLICE has a positive value, and the absolute value of OFFSET_freq is compared with SHK_DETECT_OFFSETSLICE.

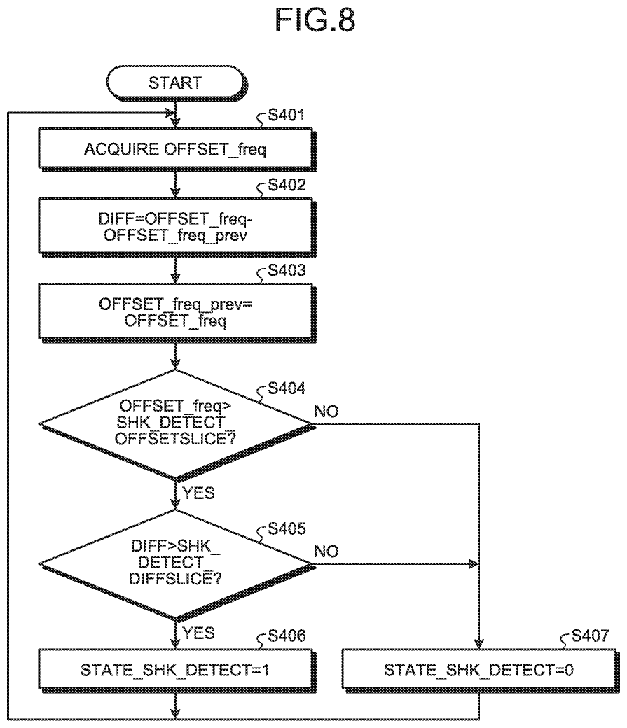

FIG. 8 is a flowchart illustrating an example of operation of shock detection performed by the magnetic disk device 1 according to the second embodiment. Note that in the figure, STATE_SHK_DETECT is a parameter to which a result of determination of whether shock is applied is set.

Firstly, when acquiring OFFSET_freq in the processing of S103 (S401), the controller 30 calculates the change of OFFSET_freq in time (DIFF) by subtracting OFFSET_freq_prev from OFFSET_freq (S402).

S401 to S406 or S407 constitutes loop processing. In OFFSET_freq_prev, OFFSET_freq acquired in the previous loop processing is set. In other words, according to the processing of S402, a difference between OFFSET_freq acquired this time and OFFSET_freq acquired last time is calculated.

Note that when the loop processing is performed for the first time, OFFSET_freq acquired in the previous loop processing is not set in OFFSET_freq_prev. An operation performed when the loop processing described above is performed for the first time can be configured appropriately. For example, it is conceivable that the controller 30 sets DIFF=0 in the first loop processing.

Following the processing of S402, the controller 30 sets OFFSET_freq to OFFSET_freq_prev (S403). This makes it possible to refer to the current OFFSET_freq as OFFSET_freq_prev in the next loop processing.

Next, the controller 30 determines whether OFFSET_freq is larger than SHK_DETECT_OFFSETSLICE (S404). More specifically, the controller 30 determines whether the absolute value of OFFSET_freq is larger than SHK_DETECT_OFFSETSLICE.

When OFFSET_freq is larger than SHK_DETECT_OFFSETSLICE (S404: Yes), the controller 30 determines whether DIFF is larger than SHK_DETECT_DIFFSLICE (S405). More specifically, the controller 30 determines whether the absolute value of DIFF is larger than SHK_DETECT_DIFFSLICE.

When DIFF is larger than SHK_DETECT_DIFFSLICE (S405: Yes), the controller 30 sets “1”, which is a value indicating that shock is applied, to STATE_SHK_DETECT (S406).

When OFFSET_freq is not larger than SHK_DETECT_OFFSETSLICE (S404: No) or DIFF is not larger than SHK_DETECT_DIFFSLICE (S405: No), the controller 30 sets “0”, which is a value indicating that no shock is applied, to STATE_SHK_DETECT (S407).

After the processing of S406 or S407, the control proceeds to S401.

The controller 30 may use a result of determination of whether shock is applied, for any process. For example, when it is determined that shock is applied, the controller 30 may perform retraction to retract the magnetic head 22 to the ramp 13. Furthermore, when data is being written to the magnetic disk 11, the writing may be stopped in response to determination that shock is applied.

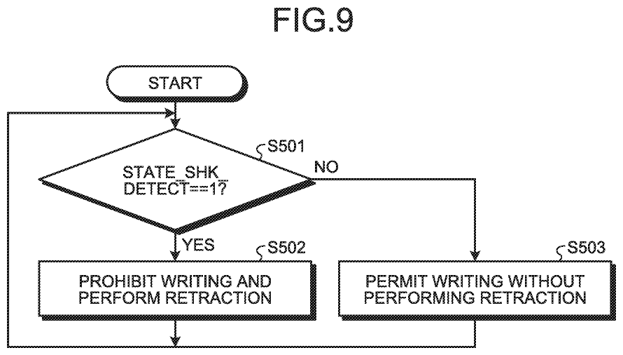

FIG. 9 is a flowchart illustrating an example of operation using the result of determination of whether shock is applied to the magnetic disk device 1, the operation being performed by the magnetic disk device 1 according to the second embodiment.

The controller 30 monitors STATE_SHK_DETECT. Then, the controller 30 determines whether STATE_SHK_DETECT is 1 (S501). If STATE_SHK_DETECT is 1 (S501: Yes), in other words, when the result of the determination indicating that shock is applied is obtained, the controller 30 prohibits writing to the magnetic disk 11 and retracts the magnetic head 22 (S502). If STATE_SHK_DETECT is not 1 (S501: No), in other words, when the result of the determination indicating that no shock is applied is obtained, the controller 30 does not retract the magnetic head 22 and permits writing to the magnetic disk 11 (S503). After the processing of S502 or S503, the control proceeds to S501.

Note that in the above example, the controller 30 detects shock on the basis of a time interval at which servo marks are read and an amount of a change of the time intervals in time. The controller 30 may be configured to detect shock by using only the time interval at which servo marks are read. In other words, the controller 30 may detect shock on the basis of only determination processing of S404.

Furthermore, the controller 30 may be configured to detect shock on the basis of an amount of a change in time with respect to time intervals at which servo marks are read. In other words, the controller 30 may detect shock on the basis of only determination processing of S405.

Note that the amount of a change in time with respect to the time intervals at which servo marks are read can be considered as the speed of a change in the time intervals at which servo marks are read. The controller 30 may detect shock on the basis of the acceleration of a change in the time intervals at which servo marks are read, that is, a time change rate of the amount of a change in time with respect to the time intervals at which servo marks are read.

In other words, the controller 30 is configured to detect shock on the basis of the time interval at which servo marks are read or appropriate numerical value information obtained by processing the time interval at which servo marks are read.

Thus, according to the second embodiment, the controller 30 measures the time interval at which servo marks are read by the magnetic head 22 and determines whether the magnetic disk device 1 is subjected to shock, on the basis of the time interval.

Therefore, it is possible to detect shock without requiring a sensor for detecting the shock. In other words, it is possible to detect shock with a simple configuration.

For example, the controller 30 performs control to retract the magnetic head 22, in response to determining that the magnetic disk device 1 is subjected to shock.

This configuration allows the magnetic head 22 to be prevented from being damaged by shock.

Furthermore, for example, the controller 30 performs control to stop writing to the magnetic disk 11 by the magnetic head 22, in response to determining that the magnetic disk device 1 is subjected to shock.

When the magnetic disk device 1 is subjected to shock, writing data incorrectly to an adjacent track to a target track by the magnetic head 22 may cause destruction of data in the adjacent track. The configuration described above can prevent destruction of data on the adjacent track due to the shock.

Furthermore, in an example, the controller 30 calculates OFFSET_freq, which is a difference between the time interval at which servo marks are read and a specified time period. Then, the controller 30 calculates DIFF, which is an amount of a change of OFFSET_freq in time. Then, the controller 30 determines whether the magnetic disk device 1 is subjected to shock, on the basis of comparison between DIFF and the threshold value SHK_DETECT_DIFFSLICE. As described above, the method of determining whether shock is applied is not limited to this description.

According to the first embodiment and the second embodiment, the controller 30 is configured to determine whether the magnetic disk device 1 is subjected to vibration or shock, on the basis of the time interval at which servo marks are read. Here, the vibration and the shock can be considered as a state in which a position of the magnetic disk device 1 varies with time relative to a predetermined position. In other words, according to the first embodiment and the second embodiment, the controller 30 determines whether the magnetic disk device 1 has transitioned from a first state where a position of the magnetic disk device 1 does not vary with time to a second state where a position of the magnetic disk device 1 varies with time, based on the time interval at which servo marks are read.

According to the first embodiment, a state where the magnetic disk device 1 is subjected to vibration corresponds to the second state. According to the second embodiment, a state where the position of the magnetic disk device 1 varies with time due to shock corresponds to the second state.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a magnetic disk on which servo marks are recorded;
a magnetic head; and
a controller that determines, based on a time interval at which the servo marks are read by the magnetic head, whether the magnetic disk device has transitioned from a first state where a position of the magnetic disk device does not vary with time to a second state where a position of the magnetic disk device varies with time.

2. The magnetic disk device according to claim 1, wherein
the controller starts loop shaping control for positioning the magnetic head, in a case that the magnetic disk device has transitioned from the first state to the second state.

3. The magnetic disk device according to claim 1, wherein
the controller determines whether the magnetic disk device has transitioned from the first state to the second state, based on comparison between a first value that is a difference of the time interval from a second value, and a third value.

4. The magnetic disk device according to claim 1, wherein
the second state is a state where vibration occurs at the position.

5. The magnetic disk device according to claim 1, wherein
the controller determines, based on comparison between a first value and a second value, whether the magnetic disk device has transitioned from the first state to the second state, the first value being an amount of a change of a third value in time, the third value being a difference of the time interval from a fourth value.

6. The magnetic disk device according to claim 5, wherein
the controller performs control to retract the magnetic head, in response to determining that the magnetic disk device has transitioned from the first state to the second state.

7. The magnetic disk device according to claim 5, wherein
the controller performs control to stop writing to the magnetic disk by the magnetic head, in response to determining that the magnetic disk device has transitioned from the first state to the second state.

8. The magnetic disk device according to claim 5, wherein
the second state is a state where the position varies due to a shock applied to the magnetic disk device.

9. The magnetic disk device according to claim 3, wherein
the controller changes a write frequency for writing data to the magnetic disk by an amount corresponding to the first value.

10. The magnetic disk device according to claim 5, wherein
the controller changes a write frequency for writing data to the magnetic disk by an amount corresponding to the first value.

11. A method of controlling a magnetic disk device, comprising:
measuring a time interval at which servo marks are read by a magnetic head, the servo marks being recorded on a magnetic disk of the magnetic disk device; and
determining, based on the time interval, whether the magnetic disk device has transitioned from a first state where a position of the magnetic disk device does not vary with time to a second state where a position of the magnetic disk varies with time.

12. The method according to claim 11 further comprising
starting loop shaping control for positioning the magnetic head, in response to determining that the magnetic disk device has transitioned from the first state to the second state.

13. The method according to claim 11 wherein
the determining includes
calculating a first value, the first value being a difference of the time interval from a second value; and
determining, based on comparison between the first value and a third value, whether the magnetic disk device has transitioned from the first state to the second state.

14. The method according to claim 11, wherein
the second state is a state where vibration occurs at the position.

15. The method according to claim 11, wherein
the determining includes:
calculating a first value, the first value being a difference of the time interval from a second value;
calculating a third value, the third value being an amount of a change of the first value in time; and
determining, based on comparison between the third value and a fourth value, whether the magnetic disk device has transitioned from the first state to the second state.

16. The method according to claim 15, further comprising
performing control to retract the magnetic head, in response to determining that the magnetic disk device has transitioned from the first state to the second state.

17. The method according to claim 15, further comprising
performing control to stop writing to the magnetic disk by the magnetic head, in response to determining that the magnetic disk device has transitioned from the first state to the second state.

18. The method according to claim 15, wherein
the second state is a state where the position varies due to a shock applied to the magnetic disk device.

19. The method according to claim 13, further comprising
changing a write frequency for writing data to the magnetic disk by an amount corresponding to the first value.

20. The method according to claim 15, further comprising
changing a write frequency for writing data to the magnetic disk by an amount corresponding to the first value.
